(19) United States
(12) Patent Application Publication
(10) Pub. No.: US 2009/0098257 A1
(43) Pub. Date: Apr. 16, 2009

(54) SELF-VENTING MICROWAVABLE PACKAGING FILM; PACKAGE USING THE FILM; AND, METHODS

(76) Inventor: Robert C. Flaherty, Loves Park, IL (US)

Correspondence Address: MERCHANT & GOULD PC, P.O. BOX 2903, MINNEAPOLIS, MN, 55402-0903, US

(21) Appl. No.: 12/248,286

(22) Filed: Oct. 9, 2008

Related U.S. Application Data
(60) Provisional application No. 60/998,488, filed on Oct. 11, 2007.

(51) Int. Cl. B65D 81/34; B65D 85/00; H05B 6/80; B32B 5/18; B32B 37/14

(52) U.S. Cl. 426/107; 219/725; 428/304.4; 156/60

(57) ABSTRACT

A package for microwave heating is provided. The package comprises a packaging film including an outer structural film having at least one set of perforations therethrough, and, an inner heat sealable film capable of being hermetically sealed to itself to form an inner package volume having no perforations therethrough that would create an aperture path through the packaging film. Typically, a non-release, heat and water stable, adhesive region is provided between the outer structural film and the inner heat sealable film. A packaging film, methods of formation of the packaging film, packages, and methods of use of the packages, are also described.

### FIELD OF DISCLOSURE

The present disclosure relates to packaging film. It particularly concerns film laminates usable as films for self-venting packaging use. An example use would be use of the film as a self-venting film in a food package.

### BACKGROUND

A wide variety packaging films are known. Such films have been used to contain materials in packages, which packages are then inserted into a microwave oven, for a heating operation. In such uses, internally of the package, during microwave heating, internal pressure is built up, due at least in part to heated water vapor. A variety of mechanisms have been developed for venting the package to release the internal pressure under such circumstances.

Improvements have been sought relating to such venting features, including: improving reliability of the venting; providing package integrity during shipping, storage and handling; and, providing cost effective materials.

### SUMMARY

According to the present disclosure, a packaging film is provided. The packaging film is useful as a self-venting film in a package, to be used, for example, in an operation of heating the contents of the bag, without prior opening of the bag. A typical use would be in a package containing a food substance, for microwave heating.

In general terms, the film is characterized as comprising a laminate including: an outer structural film comprising a film having at least one perforation region or set therethrough, preferably in a selected size, form and location as described; and, an inner heat sealable film which can be used to form a hermetically sealed inner volume. This inner heat sealable film may or may not have perforation regions fully or partially through it. There may also be one or more layers between the outer and inner to add different properties to the finished laminated film.

Typically, an adhesive is provided securing the inner film to the outer film, although alternatives are possible. The adhesive, when used, is generally chosen to be non-release, heat stable, adhesive; meaning that the adhesive does not release its adherence between the outer film and the inner film or substantially deteriorate, due to water solubility or heat/water interaction. The adhesive is, however, rupturable, along with the inner film, in appropriate use of the packaging film.

Herein, descriptions are provided of: an overall packaging film and individual laminates or regions within the film; packaging including the film; methods of formation of the film; and, methods for it use.

There is no specific requirement that a film package or method include all of the features characterized herein, in order to obtain some advantage according to the present disclosure.

### BRIEF DESCRIPTION OF THE DRAWINGS

FIG. 1 is schematic plan view of package, containing a food product, formed with a self-venting packaging film according to the present disclosure.

FIG. 1A is an enlarged, schematic, fragmentary view of a portion of the package of FIG. 1.

FIG. 2 is schematic depiction of a method of forming a packaging film according to the present disclosure.

FIG. 3 is a fragmentary, schematic, cross-sectional view of an outer film usable in the process of FIG. 2, and used to form a film formed into the package of FIG. 1.

FIG. 4 is a schematic, fragmentary, cross-sectional view of a film formed using the construction of FIG. 3, in the process of FIG. 2.

FIG. 5 is a fragmentary, schematic, cross-sectional view of the film of FIG. 4, shown being distorted during early stages of a microwave use.

FIG. 6 is schematic top plan view of an apparatus usable to provide a selected perforation set in an arrangement according to the present disclosure.

FIG. 7 is a schematic side elevational view of the apparatus in FIG. 6.

### DETAILED DESCRIPTION

### I. General Features of a Packaging Film, Package, and Use

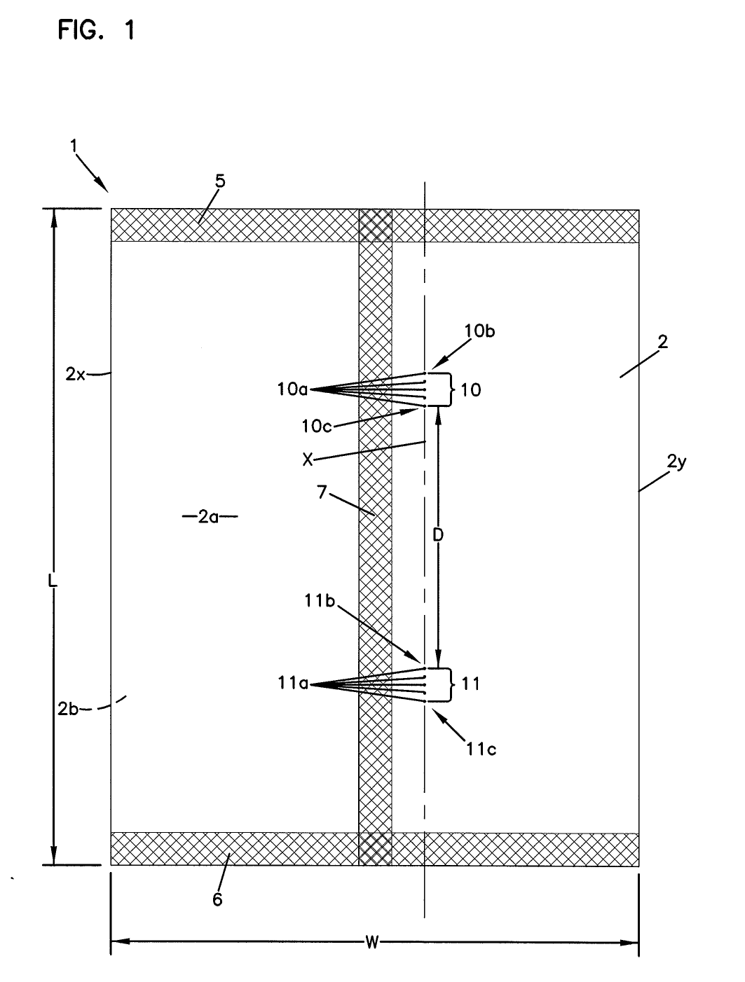

Reference numeral 1, FIG. 1, indicates an example package made with a self-venting packaging film according to the present disclosure. Referring to FIG. 1, the package 1 comprises a packaging film 2 formed into a package, (for example, with a vertical form, fill and seal apparatus (VFFS apparatus)) to provide package 1 with first and second opposite end seals 5, 6, having a longitudinal back seam 7 extending therebetween. The package 1 can be configured, for example, to define a hermetically sealed inner volume including consumable food products such as vegetables, for microwave cooking.

In a typical package 1, if made by a vertical form, fill and seal operation, end seams 5, 6 will extend generally parallel to one another, although there is no specific requirement of this in arrangements according to the present disclosure.

Package 2 can be characterized as comprising opposite back and front sides, faces or panels, 2a, 2b, respectively. Seals 5, 6 typically comprise heat seals, as does seam 7.

The seals 5, 6, and seam 7, are generally made to be heat and pressure stable. By this, and variants thereof, it is meant that the end seals 5, 6 and the seal at seam 7 are made sufficiently strong so that they do not open or vent, during use of package 1. This typically is a matter of making each of the seals 5, 6, and the seam 7, sufficiently wide, typically at least 0.375 inch (9.53 mm) inch wide.

Still referring to FIG. 1, the package 1, i.e. the packaging film 2, includes at least one perforated (burst) set or region 10 therein. The particular example package depicted includes two perforated (burst) sets or regions 10 and 11 as shown.

Each perforated (burst) set or region 10, 11 comprises a plurality of individual perforations (10a, 11a). For the example depicted, each of the perforated sets or regions 10, 11 includes five perforations (10a, 11a), although, the number can vary from this. Typically, each perforated burst, set or region 10, 11 comprises at least two perforations, usually at least three perforations, often a number within the range of 4-25, inclusive and usually a number within the range 5-12, inclusive. In a typical package or packaging film, if more than one perforation (burst) set or region is present, each will typically have the same number of perforations as the other(s), although variations from this are possible.

Herein, the term “perforation” when used in this context is meant to refer to an opening through an outer surface or film of the package 1. As will be understood from descriptions below, this opening does not extend completely through the film 2. The shape of the opening is not meant to specified by use of the term “perforation” or variants thereof. For example, the shape can be circular, or be in narrow slit (elongate) shape, if desired; and, other shapes are possible. Further, the method of formation of the perforation is not meant to be indicated, by the term. The perforation(s) 10a, 11a can result from cutting or puncturing, for example.

Although alternatives are possible, a typical package 1 will include at least one perforation (burst) set or region 10 or 11 and usually not more than five (perforation) sets or regions 10, 11. Typically, a package includes 1-4 perforation sets or regions, inclusive.

Typically, all perforation sets 10, 11 within a package 1 are included on the same face or panel (2a or 2b) of the package 1. A reason for this, relates to preferred operation and use of the package 1. In particular, during a microwave cooking operation, it is preferred to position the package 1 with the panel (2a) having the perforation region(s) or set(s) therein, directed upwardly. Thus, it will be preferred to have all perforation regions 10, 11, on the same side of the package 1. An advantage from directing perforation regions or sets 10, 11 upwardly, is that during microwave cooking, venting will occur by the bursting of the package 1, in a manner discussed below, in one or more of the perforation region(s) 10, 11. If the perforation sets or regions 10, 11 are directed downwardly, and bursting occurs, water will drain undesirably from the bag within the microwave oven. However, if perforation regions 10, 11 are directed upwardly, such a liquid drainage will not occur within the microwave oven.

In a typical package, the packaging film will include no perforations in regions other than in the perforation sets as defined. Thus, in a typical package, one panel or face will have no perforations therein, and the other panel or face will only have perforations therein oriented in perforation sets or regions in accord with the present description. (If any perforations, not included in one or more perforation sets as defined, are provided in the package, for example through the outer film, these perforations are typically acceptable if: they are such that they will not interfere with proper to burst of the perforation sets and interior gas release; and, they will not interfere with hermetic sealing and package during storage, handling and intended use.)

Although alternatives are possible, typically within each perforation set or region 10, 11, individual perforations 10a, 11a, will be co-linear. That is, typically within a perforation region 10 or 11, the individual perforations 10a, 11a are all positioned along the same line, in this instance, line X, FIG. 1.

Also, typically in each perforation set or region 10, 11, if the perforations 10a, 11a are not circular, they are generally each oriented with a longer dimension aligned with a direction of the line X. (Having the longer dimension aligned along the line “X” (in the machine direction) is easier to manufacture; however, it is contemplated to orient the perforations in any direction.)

Further, typically the line X on which the perforations within a given perforation region are aligned, is a line that extends generally parallel to the machine direction of film 2 when (if) used or in a vertical form, fill and seal operation to form the package 1, i.e. a direction corresponding to the direction of seam 7 (perpendicularly to end seams 5, 6 and parallel to said packages 2x, 2y). (Again, it is easier to manufacture the film in this manner; however, the groups of perforations do not need to be in a machine direction line.)

In addition, although alternatives are possible, in a typical package 1, multiple perforation sets or regions (for example sets or regions 10, 11) will typically be aligned co-linear; i.e. all perforations 10a of region 10 will be positioned co-linear with a line also passing through all perforations 11a in perforation region 11. That line, for the example shown, is indicated at X.

This co-linear relationship of perforation within a perforation set 10, 11, and also co-linear alignment in between perforation sets or regions 10, 11, is a result of a typical preferred process for manufacture. Alternative alignments of perforations within a group or among group regions are contemplated.

Attention is directed to FIG. 1A, depicting a fragmentary, schematic view of a portion of package 1. Here, an enlarged view of perforation sets 10, 11, is provided.

Typically, there will be at least two, usually at least three, preferably a number within 4-25, inclusive, often 5-12, inclusive, of individual, spaced, perforations (holes or slits) within each perforation set 10, 11. Typically, the length of each perforation set, 10, 11, between opposite end (or furthest apart) perforations (10b, 10c or 11b, 11c) within the set 10, 11 is at least 0.25 inch (6.3 mm) and not usually more than 1.5 inch (38.1 mm), although alternatives are possible. The typical length of each perforation set (10, 11) will be at least 0.3 inches (7.62 mm) and not more than 1.0 inch (25.4 mm).

Also, typically, the distance between opposite end perforations 10a, 11a in the various regions, 10, 11, are the same. That is, each perforation region (10, 11) extends over the same linear length (film length) of the package. Alternatives are possible, but such similarities between perforation regions (10, 11) will typically result from a preferred method of manufacture, as described below.

Typically, the spaces between perforations 10a, 11a, within a given set 10, 11, are the same. That is, the perforations within a given set are evenly spaced with respect to one another.

Typically, a spacing D, FIG. 1, between adjacent perforation regions 10, 11 is at least 1 inch (25.4 mm), usually at least 2 inches (50.8 mm), and often is within the range of 3-7 inches (76.2-178 mm), inclusive. The distance (D) between perforation regions 10, 11 is meant to refer to the distance between the most closely spaced end perforations of each region 10, 11.

Typically, the total percentage perforation area with respect the total package outer surface, is at least 0.001% and no greater than 0.1% of the total package outer surface area, typically no more than 0.05%, and is often within the range of 0.005-0.05% of the total package outer surface area. The term “total percentage perforation area” and variants thereof, is meant to refer to: the total open area of perforations 10a, 11a; divided by the total outer surface area of package 1, (calculated by taking the width W, FIG. 1, multiplied by the length L, FIG. 1, times 2), stated as a percentage.

The total percentage of the perforation area can also be stated as a percentage of a film area, calculated in an analogous manner. Here the total film area used is a perimeter definition of the film, since it is not folded over itself.

Typically, the size (open area) of each perforation 10a, 11a is no greater than 0.01 sq. inch (6.45 sq. mm), often no greater than 0.005 square inches (3.226 sq. mm), usually no greater than 0.002 square inch (1.29 sq. mm), and typically it is within the range of 0.0001 sq. inch-0.0015 sq. inch (0.065-0.97 sq. mm). If the perforation is a narrow slit, for example a razor slit, it may be impractical to measure the open area. Typically, when a razor slit or narrow slit is used, each slit (perforation) is no longer than 0.5 inch (12.7 mm); typically no longer than 0.25 inch (6.35 mm), and often within the range of 0.125-0.25 inch (3.17-6.35 mm), inclusive.

In operation, again, the package 1 will typically be formed from film 2 in a typical vertical form, fill and seal operation, to contain a consumable (edible) food, such as vegetables. Seals 5, 6 and seam 7, will have been applied as part of the vertical form, fill and seal operation. The packaging film 2 used in the form, fill and seal operation will have typically already contain the perforation sets 10, 11, before the vertical form, fill and seal operation.

The package 1 will typically be positioned in a microwave oven for use, with surface 2a (having perforation sets 10, 11) directed upwardly. As the vegetables (food) or water within an interior package 2 become exposed to the microwave energy, heat is generated, which will generate pressure (upon heating air and water vapor release) within an interior of package 2. As the internal pressure increases, an expanding stress is applied to film 2. Eventually, the stress will result in a rupturing of the film 2, as the tensile strength of film 2 within one or both of the two perforation sets 10, 11 (between the perforations 10a, 11a within a given set 10, 11) is overcome. However, when the film is constructed in a manner described herein as an example, the rupturing will generally not propagate substantially beyond the ends of each perforation region 10, 11.

Alternately stated, the perforation sets 10, 11, will burst, with the rupture generally contained between end perforations in each set. Generally, the rupture will not expand, adjoining separated or spaced perforation sets.

This rupturing will vent the pressure from within the interior of package 2.

Typically, the package is constructed from materials such that: film 2 has one side, which will become the inner side of the package, which is heat sealable and appropriate for forming a hermetically sealed volume; and, the total film is selected to have a tensile strength, in any perforation set or region, of at least 3,500 psi (246 kg/sq. cm.) and typically and not greater than 7,000 psi (492 kg/sq. cm.); often within the range of 3,500 psi-4,500 psi (246-316 kg/sq. cm.), inclusive. Typically, the package will be such that within regions where there are no perforation sets or regions, the tensile strength is sufficiently high so that it will not rupture during use, typically above 7,000 psi (492 kg/sq. cm.), usually above 8,000 psi (562 kg/sq. cm.), and often at least 9,500 psi (668 kg/sq. cm.), for example about 10,000 psi (703 kg/sq. cm.).

When the package is made from films according to the more detailed description below, typically the user will not further tear the ruptures to obtain access to the interior of the package. Rather, opening of the package will typically occur by cutting one or another of the package edges, for example, adjacent one of end seams 5 and 6.

### II. Preparation and Characteristics of the Packaging Film 2

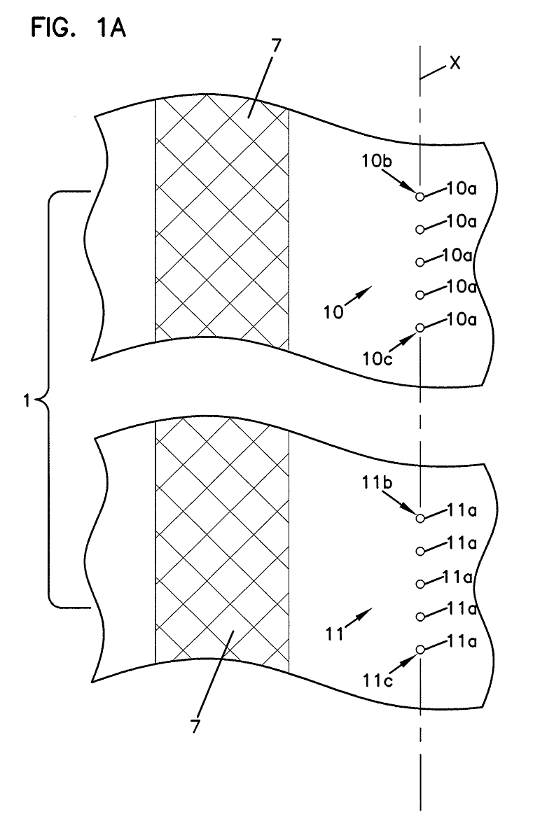

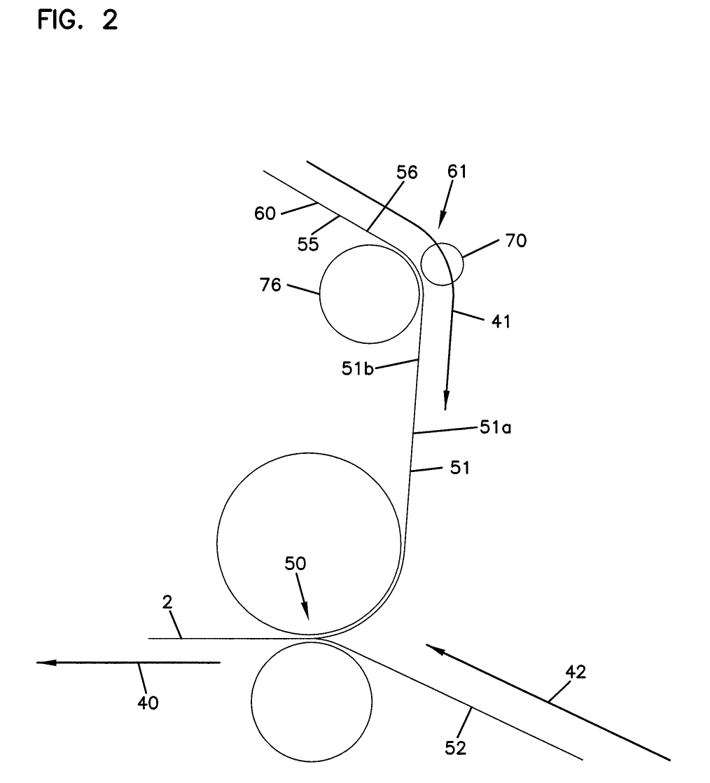

Attention is now directed to FIGS. 2-7, concerning general preparation of the packaging film 2, and its components.

Referring to FIG. 2, a schematic depiction is provided, of an approach to manufacturing packaging film 2 in a continuous manufacturing process. A packaging film 2 (used to form the package 1), FIG. 1, is shown leaving the process at arrow 40.

The packaging film 2 is formed by laminating together, at station 50, a first film 51 (fed in the direction of arrow 41) and a second film 52, (fed in the direction of arrow 42). The first film 51 will typically comprise at least an outer structural film 55. It will often include an inner adhesive region or layer 56.

It is noted that the perforations 10a are put into the film 51, at region 61, in the process characterized in FIG. 2. Thus, at the specific location indicated at 60, the film 51 would not yet have the apertures 10a therein.

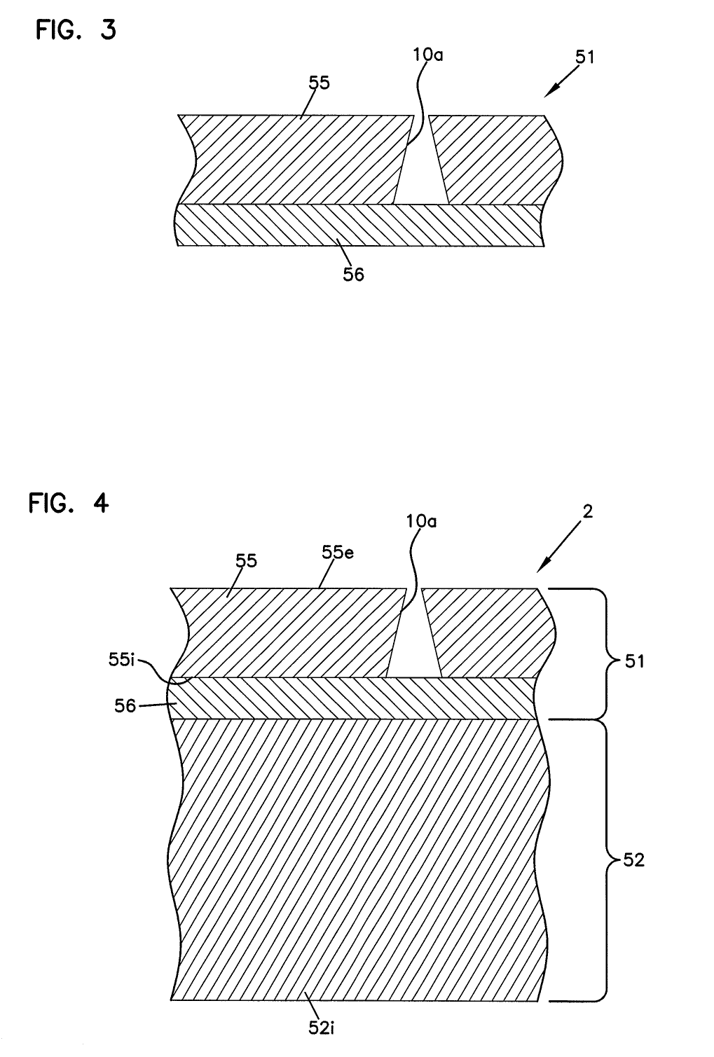

In FIG. 3, a fragmentary, cross-sectional view of film 51, after perforation, is shown. The view of FIG. 3 is schematic, and relative thickness may be exaggerated. In addition, structural film 55 and/or adhesive region 56 may comprise more than one layer.

Referring to FIG. 3, the outer structural film 55 will, in general, form the outer surface of the package 1. That is, film 2, FIG. 2, will be formed into package 1, with outer structural film 55 directed outwardly. Referring to FIG. 3, the outer structural film 55 includes apertures 10a therein. Often, apertures 10a do not propagate through the adhesive region 56, when the adhesive region is present.

Referring to FIG. 2, in the process generally referenced therein, film 60 is shown directed into station 61. Again, the film 60 will typically comprise outer structural film 55 having, on one side thereof, adhesive 56. The film 60, prior to station 61, would not include perforations (10a, 11a) therein. At station 61, apertures 10a, 11a would put into the film 55, forming film 51. The perforations 10a, 11a can be cut or punched into the film, by appropriately configured perforation forming equipment, at station 61. This can be done, for example, by pressing cutting blades or a punch arrangement directly into the film 55, or it can be done by providing the punch or cut through the adhesive region 56, and then through the film 55, for example, when the adhesive region 56 is still sufficiently flowable to close the punches or cuts made therethrough.

Referring to FIG. 3, film 51 is depicted showing an aperture 10a formed as if punched into the film 55 from the adhesive 56, with the adhesive re-sealing the punch. Thus, the operation occurred with the film 60 provided with adhesive 56 thereon, which is not fully cured, but which is sufficiently flowable that a punch therethrough will eventually close itself (in some instances in a later step).

Referring to FIG. 2, at 70 a roller (rotary die) is provided as a perforation former depicted appropriately for forming apertures corresponding to apertures 10a (or 11a). At 76 a back-up roller is depicted, against which the cutting or punching occurs. At 51, FIG. 2, is shown a film having one side 51a corresponding to the adhesive region 56, FIG. 3, and opposite side 51b, comprising a structural film 55 with perforations therethrough, formed by roller 70 pressing through the adhesive 56, then through the film 55, with adhesive 56 closing back over the perforation (at least in a laminating stop at station 50).

Still referring to FIG. 2, at 52 a second film is provided, which will form an interior film layer in the package 1 of FIG. 1. Lamination occurs at 50. It is noted that in station 50, pressure applied will tend to cause the adhesive 51a, when present, to close back over apertures 10a, 11a therethrough; and, heat applied will cause the adhesive, when present, to set, when a thermoset adhesive is used.

Referring to FIG. 4, a fragmentary, cross-sectional view of film 2 is depicted. In FIG. 4, film 55 and film 52 are shown laminated together, along an interface involving adhesive region 56. (Adhesive region 56 is typically continuous and complete in extension between films 55 and 52.)

It can be seen from FIG. 4, that, film 2, useable to form the package 1, comprises a multi-layer structure with an outer layer 55 comprising a structural film with: perforations forming perforations 10a therethrough; an interiorly directed surface 55i and an exteriorly directed surface 55e; and, inner film 52. Adhesive 56 is positioned along interiorly directed surface 55i, and provides adherence to film 52.

Either of the films 55, 52 can comprise a multi-layer structure. Some example films are described below.

When film 52 comprises a multi-layer structure, the layer which forms an interior surface of the package 1, will typically be characterized as a “exposed” or “most inner” layer. The layers between the exposed layer and the outer layer 55, will be referred to as “interior” or “unexposed” layers. Thus, the terms “exposed” and “unexposed”, when used in this context, refer to the surfaces as they appear in the final resulting film 2.

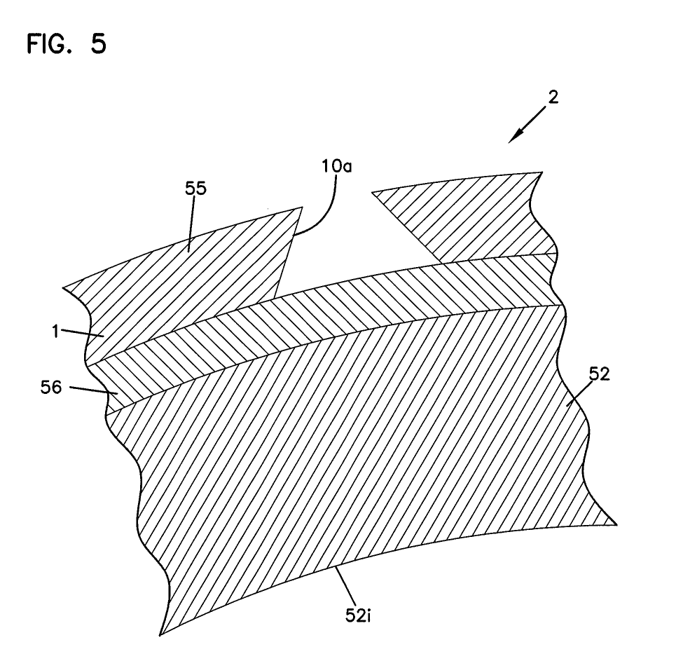

Attention is now directed to FIG. 5. FIG. 5 is intended to schematically represent a portion of package 1 with film 2 stressed outwardly under interior pressure within the package 1. It can be seen that aperture 10a expands as film layer 55 is stressed outwardly. As stress continues, eventually the tensile strength under and between spaced apertures 10a, in a perforation set 10, and through the thickness of the film 2 will be overcome, causing a rupturing or bursting of the package 1, in the perforation regions 10, 11.

Specifically, the overall film 2 has a tensile strength. However, in the regions (10, 11) of perforations through the outer structural layer 55, regions of reduced tensile strength (weak regions) are created in the film 2. As the package 1 is placed under expanding stress, eventually the tensile strength in these regions will be exceeded, and the film 2 will break.

It is noted that, referring to FIGS. 4 and 5, the inner film 52 does not include any perforations extending therethrough, at least in a region in communication with perforation (10a, 11a) through the outer layer 55. Thus, the inner film 52 can be hermetically sealed. By the term “hermetically sealed” in this context, it is meant that the seal provided by layer 52 is air tight. It is noted that typically there will be no apertures in or through inner film 52 in the film 2, prior to burst.

Typically, film 2 will be constructed such the tensile strength of the packaging film 2 in the perforation sets 10, 11, will be at least 3500 psi (246 kg/sq. cm.) and not greater than 7000 psi (492 kt/sq. cm.), usually between 3500 and 4500 psi, inclusive (246-316 kg/sq. cm.) A reason for this is that if the tensile strength is too high, the regions 10, 11 will not burst during the microwave heating operation. Typically, if the tensile strength is too low, an undesired burst during handling of the package 1 may occur. For example, if the package is contained in an unpressurized hold of airplane, or is contained in a truck going over a mountain pass, undesired bursting may occur. Also, if the tensile strength is to low, handling of package (squeezing) may cause an undesired burst.

Typically, the adhesive 56 will be selected, along with the materials for the outer film 55 and inner film 52, such that the bursting will not be as a propagation or tear through regions of film 2 between perforations in individual regions 10, 11.

Typically, the film 2 will be constructed to have a tensile strength, in regions other than where perforation sets are located, of greater than 7,000 psi (492 kg/sq. cm.), usually greater than 8,000 psi (562 kg/sq. cm.), and typically at least 9,500 psi (668 kg/sq. cm.), fore example about 10,000 psi (703 kg/sq. cm.).

Typically, the structural layer 55 will be selected from a material that has a tensile strength, when not perforated, of at least 10,000 psi (703 kg/sq. cm.), typically at least 20,000 psi (1,406 kg/sq. cm.), and often 30,000 psi or greater (2,109 kg/sq. cm.).

Also, typically, at least an inner surface 52i of film 52, which will be the surface directed inwardly of the package 1 when formed, will be selected from a material that can be readily heat sealed, for provision of seals 5, 6 and seam 7, FIG. 1.

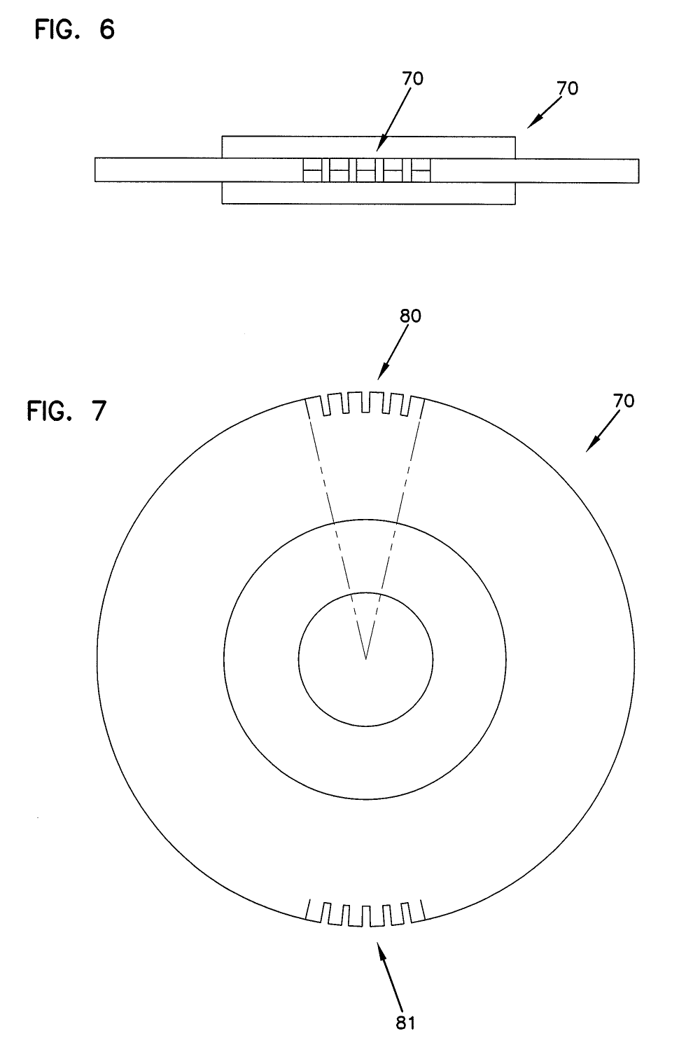

In FIGS. 6 and 7, a rotary type die cutter usable for cutting wheel 70, FIG. 2, is depicted schematically. In FIG. 6 a top plan view is shown, and in FIG. 7, a side, elevational view is shown.

Regions 80, 81 of the rotary die cutter 70 comprise punches or cutters, which will cause perforations 10a, 11a, to form. An distance between regions 80, 81, is selected to provide a appropriate spacing between perforation regions, in the resulting film and package.

Typically, the method is conducted such that perforations 10a, 11a are applied to the outer structural film 55 such that there is a number of sets within the range of 1-5 sets, inclusive, of perforation sets within a line of perforation sets corresponding to a film length of no greater than 16 inches.

It is noted that as an alternative to pressing through adhesive region 56 and then punching perforations in film 55, the die cutter 70 could oriented on an opposite side of the film to punch through the outer structural layer 55, toward the adhesive layer 56.

It is noted that in some alternate applications to the techniques described herein, film 51 can comprise a laminate that does not include a cross-linked adhesive therein. For example, film 2 can comprise an extrusion coated or laminated structure comprising a polyester film (for the outer structural film) and a layer of a film such as low density polyethylene. This film could then be adhered, for example, with another laminated film (for example, coextruded film) giving an appropriate layers for forming the inner heat sealable film. Such a second film could comprise, for example, a film which is coextruded with appropriate properties for laminate to the LDPE layer, and having an exposed layer of polypropylene. With such an approach, the perforation set(s) can be provided in the outer structural film either before coating with LDPE, or after.

In the case of creating the perforations on the entire film structure 2 after it is put together, a rotary die “kiss-cut” process or similar could be used. In this method, the film is passed between a roller and a backing plate or another roller. On the first roller, the perforation pattern is etched in relief to precise specifications. When the film is put between this patterned roll and the backing plate or roller and pressure is applied, the perforation pattern is cut into the film to the depth specified by the pattern. In this manner, the perforations may extend through one layer and stop or extend either fully through more layers or only partially through the subsequent layer.

Alternatively, the perforations through the outer and inner layers would not necessarily need to be adjoining. There could be a perforation of the outer layer penetrating part of the way through and a perforation on the inner layer toward the outer layer penetrating partially through resulting in a finished package 2 with partial perforations extending from the outside toward the inside and from the inside toward the outside but no two perforations conjoining in order to form a complete channel from the inside to the outside of the package. The perforations on opposite sides could be offset from 0″ to ¼″ of each other.

The precise depth of perforation necessary can be determined by the tensile strengths of the materials in question. In order for the entire film structure 2 to rupture during cooking in the microwave but not be compromised during filling and distribution, the area of the perforation will typically be around 3500 psi and not greater than 7000 psi, usually between 3500 psi and 4500 psi inclusive. If the tensile strength is too high the regions around perforations 10 and 11 will not burst during microwave cooking. If the tensile strength is too low, then the package 1 risks opening at regions around 10 and 11 prior to the cooking cycle. Materials that could be used in the outer layer include but are not limited to polyester film, nylon film, polypropylene film. These have high tensile strength values that will not prematurely open but can be manipulated with perforations to locally reduce tensile strengths. These films are typically in have thicknesses from 0.25 mil to 1 mil. The internal film is usually a polyolefin such as polyethylene or polypropylene. This film can be made from neat resin or modified to enhance certain properties. In addition, the internal film could be mono- or multi-layered. These films typically have thicknesses from 1 mil to 5 mil. However, the thicker the film, the more aggressive the perforation will need to be in order to sufficiently reduce the tensile strength.

While the perforation depth to achieve the given psi values is dependant on the materials and thicknesses used for the package, the total penetration will range from 5% to 90% inclusive, typically in the 10% to 40% range. This percentage is a measurement of the maximum depth of penetration if the perforations originated from only one side of the film or a sum of the maximum depth of penetration of each side divided by the total thickness of the film 2.

### IV. Example Materials

Outer structural film 55 provides general strength characteristics and outer surface characteristics to the resulting package 1. The film 55 should be chosen for these properties. It will often have a relatively low elongation, so it will tend to break or rupture when put under the expansive stress, as supposed to stretch.

Typically, usable films for outer, structural layer or film 55 will be polyester films, usually oriented, abbreviated herein as OPET. A typical usable film is an oriented polyethylene terephthalate film, for example, as available under the DuPont Mylar™ mark. Polyesters are typically preferred, since they do not stretch significantly, and thus burst is more effectively contained and controlled.

Alternative films that can be used for the outer structural film include other relatively strong, oriented polymers, such as oriented polyamides (nylons). However, typically nylons have a somewhat higher elongation that polyesters, and are less desirable.

Even materials with relative high elongation can be used for the outer film 55, for example, an oriented polypropylene film. Such materials will typically only be used when package rigidity, and package strength and stiffness are not of particular concern.

It is expected that, typically, the outer structural film 55 will comprise a oriented polyester film, usually polyethylene terephthalate. The typical thickness of the film 55 will be chosen to have an appropriate strength for the use intended. Typically, a thickness on the order of about 43 to 48 gauge (100 gauge=1 mil=0.0001 inch or 0.025 mm) will be chosen.

The adhesive layer 56, when present, will generally be chosen from an adhesive that: will provide a strong adherence in the lamination 2; will be resistant to dissolution or adhesion reduction when exposed to the levels of heat and/or hot water or steam to which exposure is expected; and, which will not undesirably stretch, but rather will burst in association the perforation regions 10, 11 under the desired operating conditions.

Typically, the adhesive, when used, will be a cross-linked, thermoset, adhesive, such as a polyurethane, acrylic or epoxy adhesive.

A thermoset adhesive, not completely cured in the operation at station 61, FIG. 2, will be in a form such that the punch or slit (perforation) can be through the adhesive layer 56 and the structural layer 55, with the adhesive 56 reclosing or reforming over the perforation, for example in a later nip. Typically, a polyurethane adhesive will not be used.

For the internal film 52, typically a desirable packaging film usable for heat sealing and forming a hermetically sealed volume will be desirable. Examples include polypropylene films. Laminates, comprising one or more polypropylene layers and one or more polyethylene layers, (for example, one or more linear low density polyethylene layers (LDPE)) can be used. In a specific example described herein below, a layer comprising LLDPE/white PP/PP is characterized, wherein LLDPE is linear low density polyethylene, PP is polypropylene, and white PP made white and modified PP is modified with plastizer. Typically, the polypropylene layer will be an exposed layer directed inwardly of the package, for heat sealing and the LLDPE layer is adjacent the adhesive 56.

Typically, the film 52 will have an overall thickness of at least 1.5 mil, usually not more than 3 mil.

### IV. An Example

A 48 gauge OPET film (Zidong Type 101 polyethylene terephthalate supplied by Pilcher Hamilton, Chicago, Ill. 60678 as Phanex CT) was coated with a polyurethane dispersion adhesive dissolved in ethyl acetate (Adcote™ 555 from Rhom and Haas, Philadelphia, Pa. 19178). A coreactant, 536 B also from Rhom and Haas, was blended with the Adcote™ 555 at 13% by weight. The mixed adhesive was coated on one side of the OPET film with a target coating weight of 2 dry pounds per 3000 square feet using a direct gravure coating method, for continuous coverage. The film was dried through a dryer to flash the solvent.

The web was then passed between an anvil roller and a perforation blade that creates intermittent perforations through the adhesive side and then through the OPET film. The blade used has a diameter 3.03 inches and is 0.2435 inches thick. There are two places where teeth are cut from the blade. The teeth have a width of 0.0449 inches and are spaced 0.031 inches apart (land width). There are eight of these teeth which result in a distance between (and including) end punches of 0.5762 inches in two places around the outer edge of the blade (arc angle=0.19 radians). The arc length between the two locations of teeth is approximately 4.1833 inches (which correspond to the package length between perforation regions). The blade has a width of 0.081 inches in the area where there are no teeth to ensure that the blade does not score the OPET film. These blades are mounted on a pneumatic holder maintaining a constant pressure of 30 psig of the blade against the anvil roller. The result is a region of eight perforations about 0.57 inches in total film length followed by a film length of approximately 4.2 inches of no perforations, and another region of eight perforations (about 0.57 inches in total film length) through only the OPET outer web.

The web travels to a heated nip station. The nip is approximately 160° F. which helps start the curing process of the adhesive. The adhesive coated and perforated OPET is nipped with a sealant web. The sealant web used in this example was a three layer coextruded film (each of X700/X701/X702 were used, each comprising LLDPE/white modified PP/PP) supplied by Ampac Performance films, Cincinnati, Ohio, 45246 The LLDPE side is oriented adjacent the adhesive, in the nip. This film is appropriate for low temperature applications.

The laminated structure is wound on a roll and stored at room temperature for ten days to ensure the adhesive is fully cured. Once cured the film is slit to the proper width for conversion on form fill and seal equipment, in this instance 16⅝ inch and 19 inch cuts.

These rolls are shipped to the packager who puts them on a vertical form, fill and seal (VFFS) machine. The film pays off of the roll and is wrapped, edge to edge, around a tube and sealed with a fin seal (inside to inside). This creates a tube of packaging material. The bottom is sealed usually at the same time the top of the previous package was created.

Frozen vegetables fall through the tube the film is wrapped around, which fills the package. The top seal is created, the package is cut from the web and packed into a cardboard case package for distribution. These cases will hold between 12 and 20 individual packages; on one example each about 8 inches wide and 10 inches long. These are stored frozen between −20 and 5° F. These packs are distributed to grocery stores to display the individual flexible packages for consumers to purchase.

### V. Some Overall Comments and Observations

According to the present disclosure, a package for microwave heating is provided. In a typical product, the package will be configured with a microwave heatable food product therein. An example food product is a microwaved vegetable product.

In general, the package comprises a packaging film which is itself a multi-layer film laminate. The multi-layer film laminate includes an outer structural film having at least one set of perforations therethrough. Typically, the outer structural film of the packaging film will comprises 1-5, inclusive, sets or regions of perforations.

Preferably, the at least one set of perforations comprises a first set of at least 2, usually at least 3, and typically 4-25 perforations, inclusive. Typically, each set or region of perforations comprises 5-12 perforations, inclusive.

Typically, each set of perforations extends over a package length, between furthest apart perforations, within at set, of no greater than 1.5 inches (38.1 mm), typically no greater than 1 inch (25.4 mm), and usually 0.3 to 1.0 inch, inclusive. (7.6-25.4 mm, inclusive).

Typically, each perforation within each set of perforations has an open area of no greater than 0.01 sq inch (645 sq. mm), typically no greater than 0.005 sq. inch (3.226 sq. mm). When the perforations are narrow slits (for example, razor cut slits) typically the perforations are no greater than 0.5 inch long (12.7 mm); typically no more than 0.25 inch long (6.35 mm), and often within the range of 0.125 inch-0.25 inch, inclusive (3.17-6.35 mm).

Typically and preferably, the package comprises a package film which has a total percentage perforation area, within the outer structural film, of no greater than 0.1% typically no greater than 0.05% and often within the range of 0.005 to 0.05% of a total package film outer surface area, within the package.

In a typical package, the packaging film will include no perforations in regions other than in the perforation sets as defined. Thus, in a typical package, one panel or face will have no perforations therein, and the other panel or face will only have perforations therein oriented in perforation sets or regions in accord with the present description. (If any other perforations are provided in the package, for example through the outer film, these perforations are acceptable if: they will not interfere with respect to burst of the perforation sets, and interior gas release with respect to the perforation set(s) as described; and, they will not interfere with hermetic sealing and package intended use.)

In one example, a package for microwave cooking has a length and includes a packaging film comprising of a multi-layer laminate; the multi-layer laminate includes: (i) at least one set of perforations comprising at least two distinct perforations extending up to the package length between farthest spaced apart perforations within the first set of perforations of no greater than 1.5 inches; (ii) a depth of penetration of the perforations through the packaging film of between 5% and 90% inclusive; and (iii) a tensile strength of the packaging film in portions of the perforations being at a level that perforations will burst responsive to pressure produced by steam from microwave cooking.

In one application, the tensile strength of the packaging film in portions of the perforations is between 3500 psi and 7000 psi inclusive.

In one example, the multi-layer laminate includes an outer structural film; an inner heat sealable film sealed to itself to form a hermetically sealed inner package volume; and a non-release, heat and water stable, adhesive region between the outer structural film and the inner heat sealable film.

The multi-layer film laminate of the package film also includes, in addition to the outer structural film, an inner heat sealable film having no perforations therethrough which create an aperture path through the package film. That is, although typically the inner heat sealable film has no perforations therethrough at all, (i.e. it is typically imperforate), if it does include any perforations therethrough, those perforations are not in communication with perforations in the outer structural film, in such a manner that would create an aperture path through the package film, in the package. Alternately stated, the multi-layer film laminate in the package forms a hermetically sealed package. By “hermetically sealed” in this context, it is meant air tight.

An example multi-layer packaging laminate, the package or package film, according to the present disclosure, includes a non-release, heat and water stable, adhesive region provided between the outer structural film and the inner heat sealable film. By “non-release, heat and water stable” in this context, it is meant that the adhesive is resistant to release or deterioration during a microwave heating process involving in the package. As will be understood from previous descriptions, this adhesive region will burst during use of the package, but the adhesive region will not release and will not be substantially deteriorated by heat and/or water. Thus, for example, it will not propagate an aperture region between the outer structural film and the inner heat sealable film.

It is noted that here and above an alternate structure, including no adhesive therein, is described.

In a typical package, the outer structural film of the multi-layer laminate will comprise 1 to 5 sets, inclusive, of perforations, each set being generally in accord with the definitions provided.

Further, each set of perforations will typically be spaced apart from each other set of perforations within the package by a package length of at least 1 inch (25.4 mm), typically at least 2 inches (50.8 mm) and typically 3-7 inches, inclusive (76.2-178 mm).

In a typical package arrangement according to the present disclosure, each perforation, in a selected set (region) of perforations within the packaging film, is oriented co-linear with each other perforation within the same set or region. By “co-linear” in this context, it is meant that each perforation within a set is oriented such that a hypothetical straight line can be drawn through them.

Typically, if the perforations, within a selected set, are not generally circular, they are oriented with a longer dimension along a line passing through all perforations in the set.

Further, in a typical package according to the present invention, when the package includes more than one region or set of perforations, each set is typically oriented such that each set (region) of perforations is positioned co-linear with each other set (region) of perforations. By “co-linear” in this context, it is meant that the perforations of each set (region) are oriented such that a hypothetical straight line can be drawn through all perforations in the outer structural layer.

Although alternates are possible, typically, the package will have a perimeter with a length within the range of 6 inches to 16 inches (152.4-406.4 mm), inclusive; and, a width within the range of 4 inches to 12 inches (101-305 mm), inclusive. An example package is a vegetable package having a width dimension of 8 inches (203 mm) and a length dimension 10 inches (254 mm), inclusive.

Such a package will typically include first and second opposite, end heat seals, each of which is heat resistant and non-releasable. By the term “heat resistant and non-releasable” in this context, it is meant that the end seals do not open, under the circumstances of package use during heating within a microwave oven,

Typically, the package includes a longitudinal heat seal seam extending between the first and second opposite end seals. Such a longitudinal heat seal seam typically extends perpendicularly to the opposite end heat seals, and is itself heat resistant and non-releasable in accordance with the definition provided above.

A typical package is formed from a vertical form, fill and seal operation, although alternatives are possible.

In a typical package, each set of perforations is positioned along a line co-linear with the longitudinal heat seam, although alternatives are possible.

In a typical package, the adhesive region between the outer structural film and the inner heat sealable film is continuous in extension therebetween and includes no apertures or perforations, therein. Further, the adhesive region typically extends across the perforation regions within the outer structural layer of the film.

In a typical package, the adhesive region is typically a cross-linked thermoset adhesive, for example, selected from the group consisting essentially of polyurethane acrylic and epoxy adhesives. In an example described, the adhesive region is a polyurethane adhesive.

The outer structural film is typically a single layer film. Often a single layer film is selected from either oriented polyesters or oriented nylons. In the example described, the outer structural film is an oriented polyester, in particular an oriented polyethylene terephthalate.

In a typical package, the inner heat sealable film comprises a 1-9 layer film, typically a 1-5 layer film, usually a 1-3 layer film. An innermost (exposed) layer of the inner heat seal film (whether one layer or more) typically comprises a heat sealable polypropylene layer, capable of forming a hermetically sealed inner package volume. In the example described, the inner heat sealable film comprises a multi-layer structure with an inner polypropylene layer and an outer layer of polyethylene or polypropylene. In one example the inner heat sealable film comprises an innermost (exposed) layer of polypropylene and outermost (unexposed) layer of linear low density polyethylene. In a particular example, the inner heat sealable film comprises a 3-layer laminate with an innermost (exposed) layer of polypropylene, a center (unexposed) layer of modified polypropylene and an outer (unexposed) layer of polyethylene, in particular, linear low density polyethylene; the outer (unexposed) layer being adjacent the adhesive layer.

The typical package for microwave heating according to the present disclosure, comprises a film having a tensile strength in portions of the film corresponding to the at least perforation region, of the at least 3,500 psi (246 kg/sq. cm.) and not more than 7,000 psi (492 kg/sq. cm.), typically 3,500 psi-4,500 psi (246-316 kg/sq. cm.). Typically, the strength of the film in regions not corresponding to the perforation regions, is greater than in the perforation sets, usually above 7,000 psi (492 kg/sq. cm.), typically more than 8,000 psi (562 kg/sq. cm.), and often 9,500 psi (666 kg/sq. cm.) or greater, for example about 10,000 psi (703 kg/sq. cm.). To accomplish this, typically an outer structural film is chosen which has a tensile strength (when not perforated) in the order of at least 10,000 psi (703 kg/sq. cm.), typically at least 20,000 psi (1,406 kg/sq. cm.), and often 30,000 psi (2,109 kg/sq. cm.) or greater.

According to the present disclosure, a package food product comprising a package in accord with the above general descriptions is provided with an edible food product contained therein, positioned within a hermetically sealed inner volume. An example package food product described, is packaged microwave vegetables.

Also, in accord with the present disclosure, the packaging film for use in forming a packaged microwave heat sealable product is provided. The packaging film in general is in accord with the film described above, incorporated in a package described above.

Also, according to the present disclosure, a method of forming a packaging film for use in packaging microwave heatable products is provided. The method comprises steps of forming an outer laminate comprising an outer structural film as previously described, for example with a non-releasable heat and water stable adhesive region thereon. Typically, the adhesive region, when used, is provided covering the entire extent of one surface of the outer structural film, including being in extension over perforations through the outer structural film.

The method includes securing the outer film to an inner heat sealable film as previously described.

In one method described, the step of forming an outer film comprises forming the at least one set of perforations through the outer structural film by forming the perforations in the film comprising the outer structural film in the adhesive region. That is, the perforations are formed after the film comprising the outer structural film and the adhesive region is formed.

The step of forming the perforations can comprise directing a perforation former against an adhesive side of the outer film, and allowing residual perforations through the adhesive region to close. Alternatively, the step of forming the perforations can comprise directing a perforation former against an outer structural film side of the outer film. An example perforation former described herein is a rotatable die.

In general terms, a method of forming a packaged film product is described which comprises using a film as previously described in a vertical form, fill and seal operation.

A method of microwave heating a packaged food products is described, which comprises placing a package according to the previous descriptions in a microwave oven and exposing the package to microwave energy at least until at least one of the (at least one) regions or perforations burst open under internal pressure caused within the package.

Typically, the package is formed with perforation regions on only one side panel or face thereof, and the package is placed in the microwave oven with the side having perforations thereof oriented upwardly.

Herein, a number of specific examples of features and steps are described. There is no specific requirement that a product or process in accord with the present disclosure, incorporate all the specific features and steps described. Variations are possible, within the scope of the general disclosure.

What is claimed is:

1. A package for microwave cooking; the package having a length and comprising:
(a) a packaging film comprising of a multi-layer laminate; the multi-layer laminate including:
(i) at least one set of perforations comprising at least two distinct perforations extending up to the package length between farthest spaced apart perforations within the first set of perforations of no greater than 1.5 inches;
(ii) a depth of penetration of the perforations through the packaging film of between 5% and 90% inclusive; and
(iii) a tensile strength of the packaging film in portions of the perforations being at a level that perforations will burst responsive to pressure produced by steam from microwave cooking.

2. A package according to claim 1 wherein the tensile strength of the packaging film in portions of the perforations is between 3500 psi and 7000 psi inclusive.

3. A package according to claim 1 wherein the multi-layer laminate includes an outer structural film; an inner heat sealable film sealed to itself to form a hermetically sealed inner package volume; and a non-release, heat and water stable, adhesive region between the outer structural film and the inner heat sealable film.

4. A package according to claim 3 wherein the at least one set of perforations is in the outer structural film.

5. A package according to claim 1 wherein the at least one set of perforations comprises a number of perforations within the range of 4-25, inclusive.

6. A package according to claim 3 wherein:
(a) the outer structural film includes 2-5 sets, inclusive, of perforations;
(i) each set of perforations including a number of perforations within the range of 4 to 25, inclusive;
(ii) each set of perforations extending over a package length, between furthest spaced apart perforations within the set, of no greater than 1.5 inch; and,
(iii) each set of perforations being spaced apart form each other set of perforations by a film length of at least 1 inch.

7. A package according to claim 1 wherein each perforation, in each selected set of perforations, is oriented co-linear with each other perforation within the selected set.

8. A package according to claim 1 including:
(a) first and second, opposite, end heat seals,
(i) each of the first and second opposite end heat seals being heat resistant and non-releasable; and
(b) a longitudinal heat seal seam extending between the first and second, opposite, end heat seals and extending generally perpendicular thereto,
(i) the longitudinal heat seal seam being heat resistant and non-releasable.

9. A package according to claim 8 wherein each set of perforations is positioned along a line parallel to the longitudinal heat seam.

10. A package according to claim 3 wherein:
(a) the adhesive region is continuous in extension;
(b) the inner heat sealable film is imperforate; and
(c) the outer structural film is a single layer film.

11. A package according to claim 3 wherein:
(a) the inner heat sealable film comprises a 3-layer laminate with:
(i) an innermost, exposed, layer of polypropylene;
(ii) a center, unexposed, layer of modified polypropylene; and
(iii) an outer, unexposed, layer of polyethylene.

12. A package according to claim 1 wherein:
(a) the film has a tensile strength in portions of the film corresponding to at the least one set of perforations at least 3,500 psi and not more than 7,000 psi; and
(b) the film has a tensile strength, in regions not corresponding to the at least one perforation region, of greater than 7,000 psi.

13. A package according to claim 3 further comprising:
(a) an edible food product contained within the hermetically sealed inner volume.

14. A packaging film for use in forming packaged microwave heatable products, the packaging film comprising a multi-layer laminate including:
(a) a structural film having at least one set of perforations therethrough;
the at least one set of perforations comprising a first set of at least two perforations, extending over a package length between farthest spaced apart perforations within the first set of perforations, of no greater than 1.5 inch;
(i) each perforation, within the first set of perforations, having an open area of no greater than 0.01 sq. inch;
(ii) a tensile strength of the structural film in portions of the perforations being between 3500 psi and 7000 psi inclusive; and
(b) a heat sealable film that is sealable to itself to form a hermetically sealed inner package volume.

15. A packaging film according to claim 14 including:
(a) a non-release, heat and water stable, adhesive region between the outer structural film and the inner heat sealable film.

16. A packaging film according to claim 14 wherein:
(a) the at least one set of perforations comprises a number of perforations within the range of 4-25, inclusive.

17. A packaging film according to claim 14 wherein:
(a) the outer film includes multiple sets of perforations;
(i) each set of perforations including 4 to 25 perforations, inclusive;
(ii) each set of perforations extending over a film length, between furthest spaced apart perforations within the set, of no greater than 1.5 inches; and,
(iii) each set of perforations being spaced apart form each other set of perforations by a film length of at least 1 inch.

18. A method of forming a packaging film for use in packaging microwave heatable products; the method comprising a step of:
forming a multi-layer laminate; the laminate including a structural film having at least one set of perforations comprising at least two distinct perforations extending between farthest spaced apart perforations within the first set of perforations of no greater than 1.5 inches; a depth of penetration of the perforations through the packaging film of between 5% and 90% inclusive; and a tensile strength of the packaging film in portions of the perforations being at a level that perforations will burst responsive to pressure produced by steam from microwave cooking.

19. A method according to claim 18 further comprising securing a side of the structural film to a heat sealable film having no perforations therethrough to create an aperture path through the packaging film.

20. A method according to claim 19 including providing an adhesive region on the structural film and adhering the structural film to the heat sealable film with the adhesive therebetween.
